(19) United States
(12) Patent Application Publication
(10) Pub. No.: US 2018/0032989 A1
(43) Pub. Date: Feb. 1, 2018

(54) Method and System for Improved Credit Transaction

(71) Applicants: John Clarke, Dublin (IE); Simon Dermot Cruise, Greystones (IE)

(72) Inventors: John Clarke, Dublin (IE); Simon Dermot Cruise, Greystones (IE)

(21) Appl. No.: 15/655,679

(22) Filed: Jul. 20, 2017

Related U.S. Application Data
(60) Provisional application No. 62/367,774, filed on Jul. 28, 2016.

(51) Int. Cl. G06Q 20/20; G06Q 20/24; G06Q 20/40

(52) U.S. Cl. CPC G06Q 20/206; G06Q 20/4093; G06Q 20/24

(57) ABSTRACT

The invention provides an improved method and system of mobile credit payment at point of sale. The invention eliminates integration and EMV certification, and provides for automatic updating of each subscriber merchant at point of sale. The invention teaches use of an inventive GoChip application on a mobile device that interacts with point of sale application on said device, and with pre-certified payment channel, such as, for example, WorldNet. The combination of the GoChip app and WorldNet provides a robust mobile payment method and system that can be rolled out in very short time, with no integration coding, no certification, and automatic updating replacing manual updating.

### Related Applications

This application is related to and claims priority from U.S. provisional application 62/367,774 filed Jul. 28, 2016, the entirety of which is incorporated by reference as if fully set forth herein.

### GOVERNMENT FUNDING

None

### FIELD OF USE

The invention is related to the field of electronic transactions, and more particularly to mobile device enabled credit card payment systems.

### BACKGROUND

Credit Cards in the US market have traditionally been based on Magnetic Stripe Technology (MSR). This is the familiar magnetic stripe on the back of every credit card, that is read when the credit card is “swiped” at the Point of Sale (POS).

It is estimated that there are 14,000,000 acceptance points in the US market, where credit cards may be swiped.

In recent years there has been a push to move the US towards “chip” technology, where the credit card information is encoded on a chip on the credit card. When a chip card is used at a POS, the card information is read from the chip, as opposed to being read from the magnetic stripe.

This chip technology is known as “EMV”, after the card schemes who originally defined the standard (Europay, Mastercard & Visa—EMV).

The challenge is that all 14,000,000 acceptance points in the US market have to be upgraded to accept EMV transactions, as well as MSR ones (the two techologies will co-exist in the market dring a “migration period”, likely to last for many years).

Implementing EMV technology at the POS presents many challenges, and is not a straightforward process of swapping out existing MSR-reading devices for EMV-reading devices, as all steps in the transaction flow are impacted by the change.

A number of existing industry players in the credit card payment space (e.g. Ingenico, Verifone) have attempted to facilitate the migration from MSR to EMV by providing the developers of POS solutions with Software Developer Kits (SDK's) capable of supporting EMV.

This approach requires the POS developer to perform several steps:
Step one: obtain the latest version of the solution providers SDK (Software Developer Kit)
Step two: integrate the SDK into their current POS environment
Step three: perform an EMV certification with each credit card
   Card Schemes (Visa, Mstercard, etc.)
Step four: upgrade—On an on-going basis, obtain the latest version of the SDK, upgrade their POS to use the latest version, and then distribute this new version to all of the merchants using the POS solution.

Of the above, Steps two, three and four are time consuming tasks that requires much manual intervention by the POS developers.

The integration process—step 2—requires a software developer from the POS company to develop code to support the integration. Developing code to support the integration requires, typically, several weeks of work to complete.

Performing an EMV certification—step 3—, is a very time consuming process that takes between three months and one year to complete.

The fourth step—upgrading and distributing upgraded, integrated version-i.e. making sure all of the customers (merchants) using the POS always have the latest version—is an on-going problem with all SDK solutions. Currently no automated solution exists, leaving the problem to be addressed manually. Each POS developer may supply their solution to thousands of individual merchants. For each SDK release, each POS developer must perform an update with each of these thousands of individual merchants. Consequently, this can be a very time consuming process.

What is needed is: an improved payment system that requires little manual intervention from point of sale (POS) developers. What is also needed is a reduction of integration time, i.e. a lessening of the need of a software developer kit (SDK) that typically requires weeks to integrate supporting code by the point of sale (POS) company. What is also needed is a less time consuming process for obtaining an EMV certification, which currently takes 3 to 12 months to obtain.

What is also needed is a method of ensuring all of the customers (merchants) using a given POS solution always have the latest version. What is needed is a method of ensuring that each POS developer provides updated POS solutions to merchants in a rapid and cost effective manner.

### BRIEF SUMMARY OF THE INVENTION

The invention taught herein satisfies at least the above recited unmet needs. The invention provides reduction of the need of a software developer kit (SDK) that requires weeks to integrate supporting code by the point of sale (POS) company. The invention provides an alternative, far simpler process than integrating an SDK into an existing POS app, effectively bypassing the need for an “SDK integration step”.

The invention also provides a less time consuming process for obtaining an EMV certification, which currently takes 3 to 12 months to obtain.

What is also provided is a method of ensuring all of the customers (merchants) using a given POS always have the latest version. What is provided is a method of satisfying the requirement that each POS developer supplying their solution to a plurality individual merchants, and always runs the most updated version.

The invention provides an improved method and system of mobile credit payment at point of sale. The invention eliminates integration and EMV certification, and provides for automatic updating of each subscriber merchant at point of sale. The invention teaches use of an inventive GoChip application on a mobile device that interacts with point of sale application on said device, and with pre-certified payment channel, such as, for example, WorldNet. The combination of the GoChip app and WorldNet provides a robust mobile payment method and system that can be rolled out in very short time, with no integration coding, no certification, and that is updated automatically.

In a preferred embodiment, the invention provides a method for mobile device credit card payment, where, at point of sale, a request is made for a credit transaction on said mobile device by a point of sale application, said method comprising the steps of:
sending code from point of sale application running on said mobile device to a second application running on said mobile device, wherein said second application performs the steps of:

identifying chip device;

interacting with chip device;

collecting information;

communicating with entity performing transaction certification; and

receiving response from bank via entity performing transaction certification;

communicating with said first application at point of sale, where such first application at point of sale provides any of data, receipts, and a screen display.

The invention also provides an improved mobile credit card EMV processing method, said improvement comprising:
launching an second app together with POS application
where said second application is directable by said point of sale application to process amount of transaction, and said second application identifies EMV device, and said second application performs the steps of

identifying chip device;

interacting with chip device;

collecting information;

communicating with entity performing transaction certification;

receiving a response from bank via entity performing transaction certification;

communicating with said first application at point of sale; and where said first application at point of sale provides any of data, receipts, and screen display.

Other embodiments not set forth herein may nonetheless fall within the scope of the claims accompanying these drawings and specification.

### BRIEF DESCRIPTION OF THE DRAWINGS

The drawings are provided as an aid to understanding.

FIG. 1 depicts a step in an exemplar transaction in a system and method according to the invention.

FIG. 2 depicts a step in an exemplar transaction in a system and method according to the invention

FIG. 3 depicts a step in an exemplar transaction in a system and method according to the invention

FIG. 4 depicts a step in an exemplar transaction in a system and method according to the invention

FIG. 5 depicts a step in an exemplar transaction in a system and method according to the invention

FIG. 6 depicts a step in an exemplar transaction in a system and method according to the invention

FIG. 7 depicts a step in an exemplar transaction in a system and method according to the invention

FIG. 8 depicts a step in an exemplar transaction in a system and method according to the invention

FIG. 9 depicts a step in an exemplar transaction in a system and method according to the invention

FIG. 10 depicts a step in an exemplar transaction in a system and method according to the invention

### DETAILED DESCRIPTION OF A PREFERRED EMBODIMENT OF THE INVENTION

For convenience, here is a brief listing of abbreviations and acronyms for easy reference.
App: application—a computer application; a set of computer implementable instructions
Chip: a microchip
EMV—Europay, Mastercard & Visa
MSR—Magnetic Stripe Reader
POS—point of sale
POS app—point of sale application
SDK—software development kit
GoChipApp—a commercial name assigned to the application that performs steps according to the invention. For more information see the website of WorldNet.
WorldNetGateway—a transaction gateway. For more information see the website of WorldNet.
Mobile platforms—specifically iOS and Android; operating systems for mobile devices

Useful definitions are also provided, to aid in understanding the description of the inventions.

App SwtichBack; as commonly understood.

This invention provides an inventive method and system, which provides a downloadable computer application (referred to below as the “GoChipApp”) which provides solutions to at least the unmet needs recited hereinabove.

The GoChip is distributed as a mobile application, and not as an SDK—not a software development kit. Hence, as there is no SDK, there is no integration step. So the SDK integration step is removed.

The GoChip App has been approved as a “pre-certified EMV solution” by credit card Processors, so any POS developer using the invention does not need to perform an independent EMV certification, and instead can passport onto the EMV certification of the GoChip App (removing the EMV certification step above).

The GoChip App uses the existing infrastructure for Mobile App Updates to provide an automated solution to the Upgrade issue (the same infrastructure that all users of Apps on smartphones utilize, but which has not been used for the updating of credit card solutions). The POS developers no longer have to concern themselves with ensuring their merchants have the latest version of the EMV solution, as the GoChip App is configured ensures that this takes place automatically.

The GoChip App requires that the POS solution is running as an application on a modern mobile platform (e.g. an iPad, or Android tablet).

The GoChip App runs as a separate, standalone App, running on the same mobile device as the POS App.

The GoChip App exploits the “App Switching” capabilities of iOS and Android in the credit card environment.

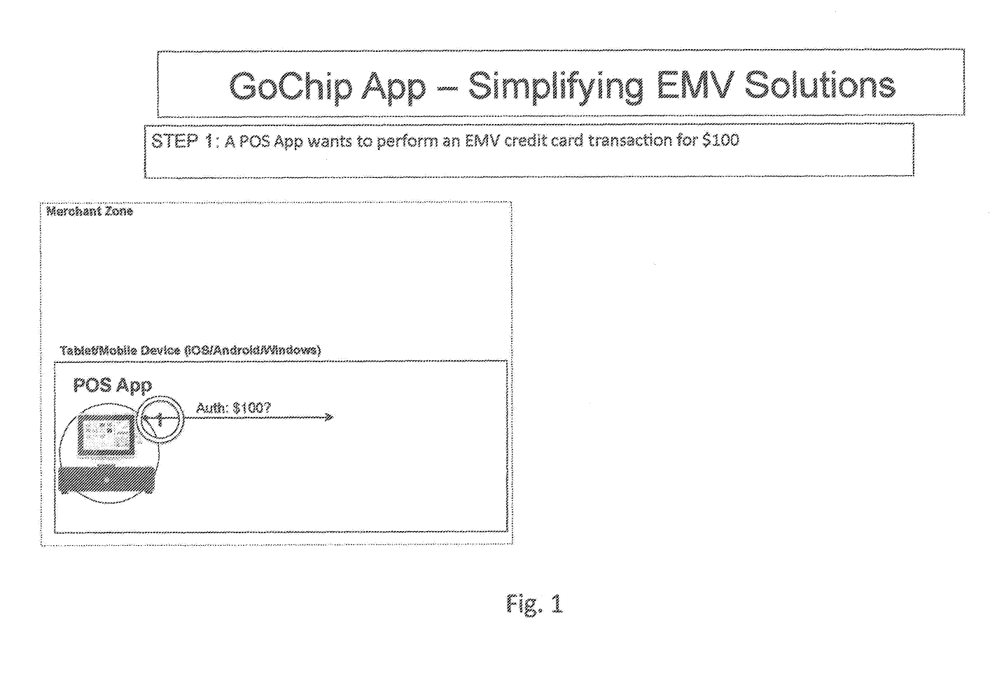

An example of the steps in performing a credit card transaction using the inventive GoChip App are outlined in Drawings filed herewith, FIGS. 1 through FIG. 10 and in the accompanying text herein below. The Steps are set forth in the paragraphs below, numbered from Step 1 to Step 9.

Step 1: on a mobile platform run the POS solution as an application, and have the inventive GoChipApp installed. The GoChip App requires that the POS solution is running as an App on a modern mobile platform. See FIG. 1.

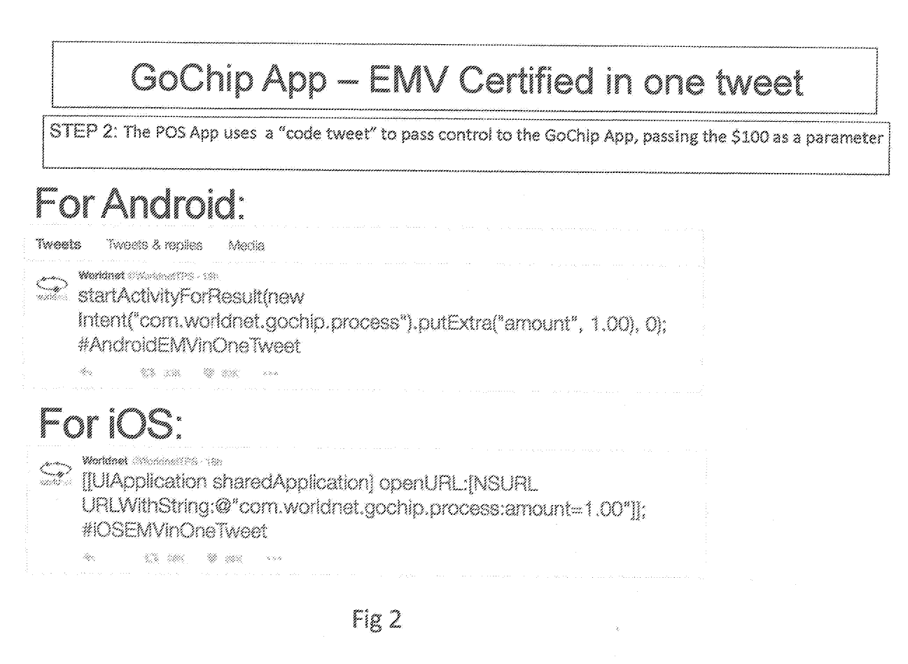

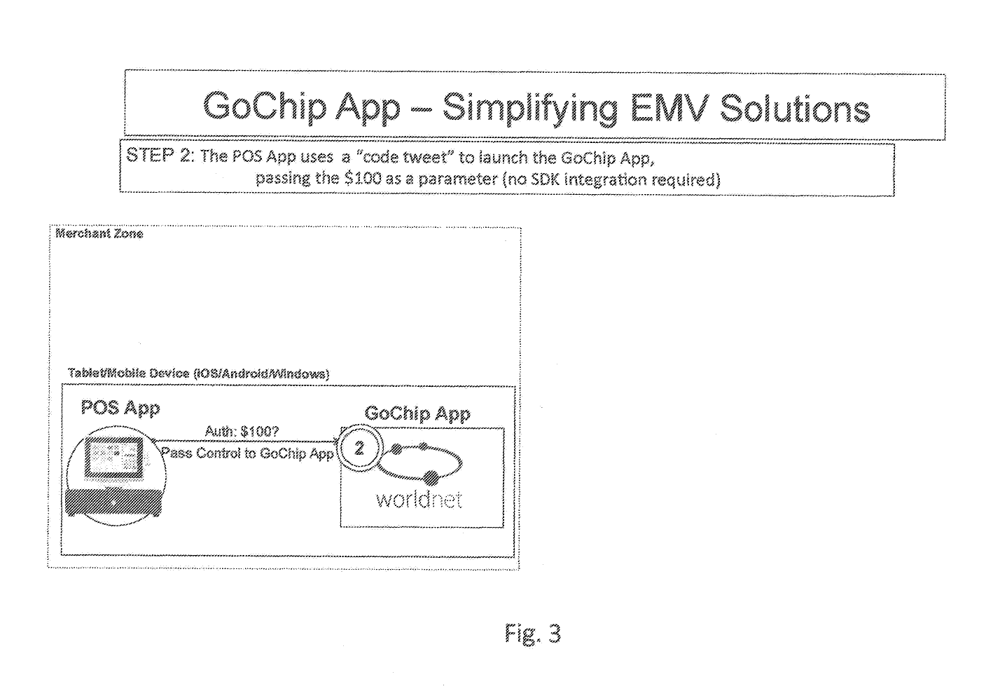

Step 2: To perform POS transaction, POS App transfers control to GoChip App using a single line of code—see FIG. 2—and passing as a parameter the amount of the transaction. See FIG. 3: To perform a credit card transaction, the POS App (running as an application on a mobile device) uses a single line of code to transfer control to the GoChip App, passing as a parameter the Amount of the transaction (e.g. $100.00).

In the case of an Android device, the following line of code is required (for an amount of $1.00):

startActivityForResult(new Intent(“com.worldnet.gochip.process”).putExtra(“amount”, 1.00), 0);

In the case of an iOS device, the following line of code is required (e.g. for an amount of $1.00):

[[UIApplication sharedApplication] openURL:[NSURL URLWithString:@“com.worldnet.gochip.process:amount=1.00”]];

It can be appreciated that this invention provides a process far simpler than that requiring integration of an SDK into an existing POS app. The invention completely obviates the necessity of any “SDK integration step”

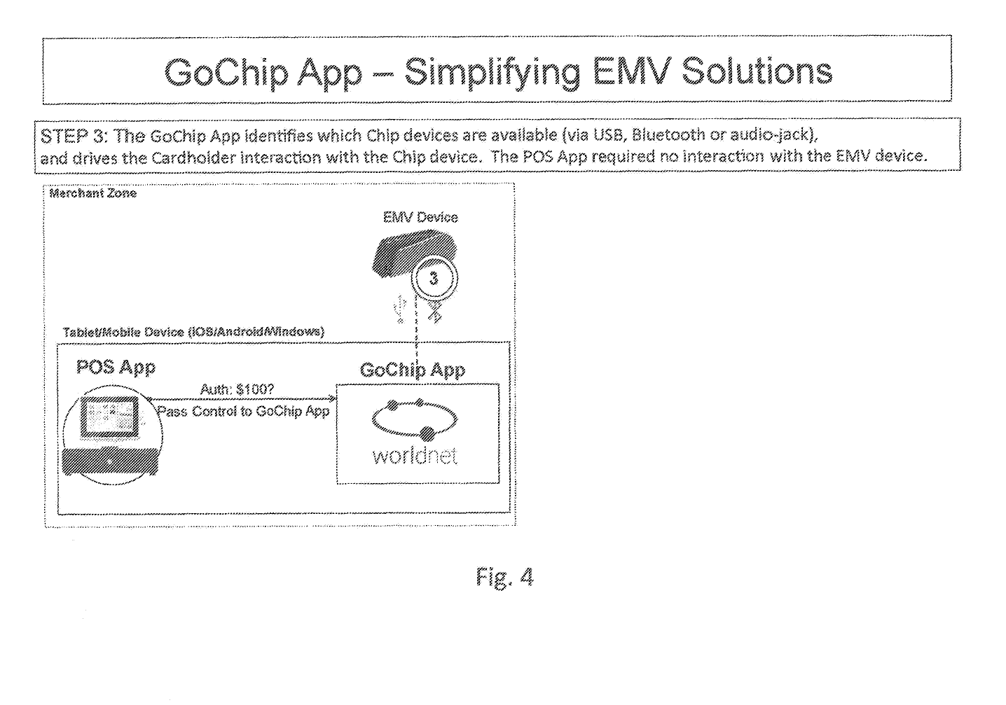

Step 3:The GoChip App identifies which physical Chip card reading devices are available (via USB, Bluetooth or audio-jack), and drives the Cardholder interaction with the Chip device. Thus, the POS App required no interaction with the EMV device. See FIG. 4.

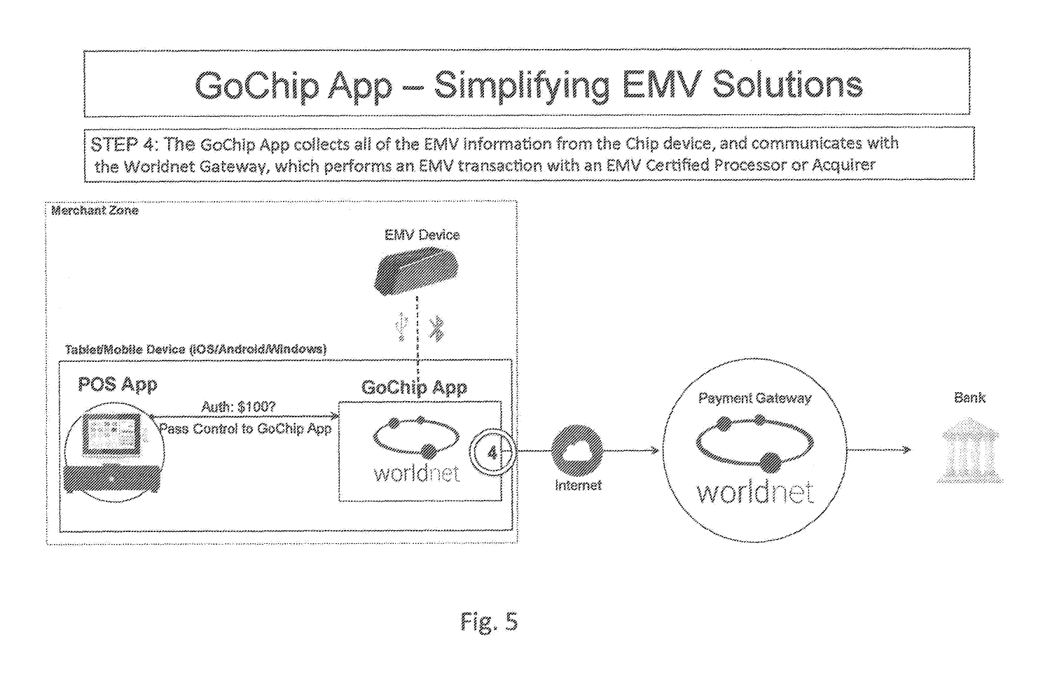

Step 4 (See FIG. 5);GoChipApp collects all of the EMV information from the chip device; communicates with the WorldNetGateway. The WorldNetGateway performs an EMV transaction with an EMV Certified Processor or Acquiror,

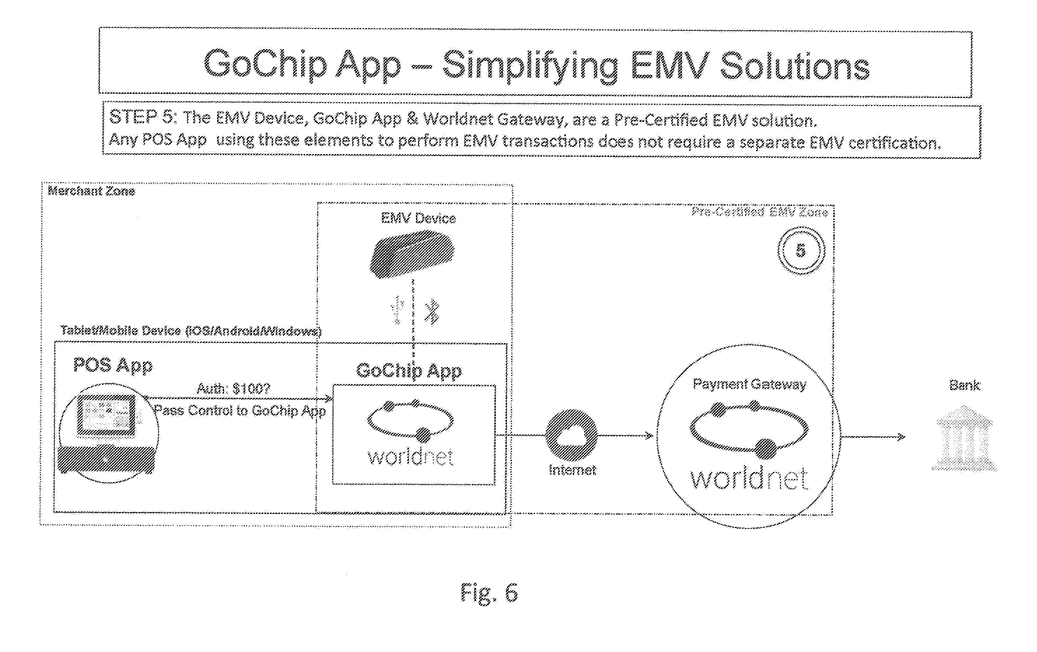

Step 5(See FIG. 6) precertified solution: EMV device, GoChipApp and WorldNetGateway. POS does not need independent EMV certification.

Worldnet's ‘GoCHIP’. Combined with Worldnet's integrated eCommerce and Virtual Terminal services, GoCHIP offers the complete suite of integrated omni-channel credit and debit card processing solutions.

Software providers will benefit from Worldnet's Level 1 PCI DSS certification, eradicating the need for the provider to become PCI Compliant. The GoChipApp is available for Android and iOS and can be integrated seamlessly.

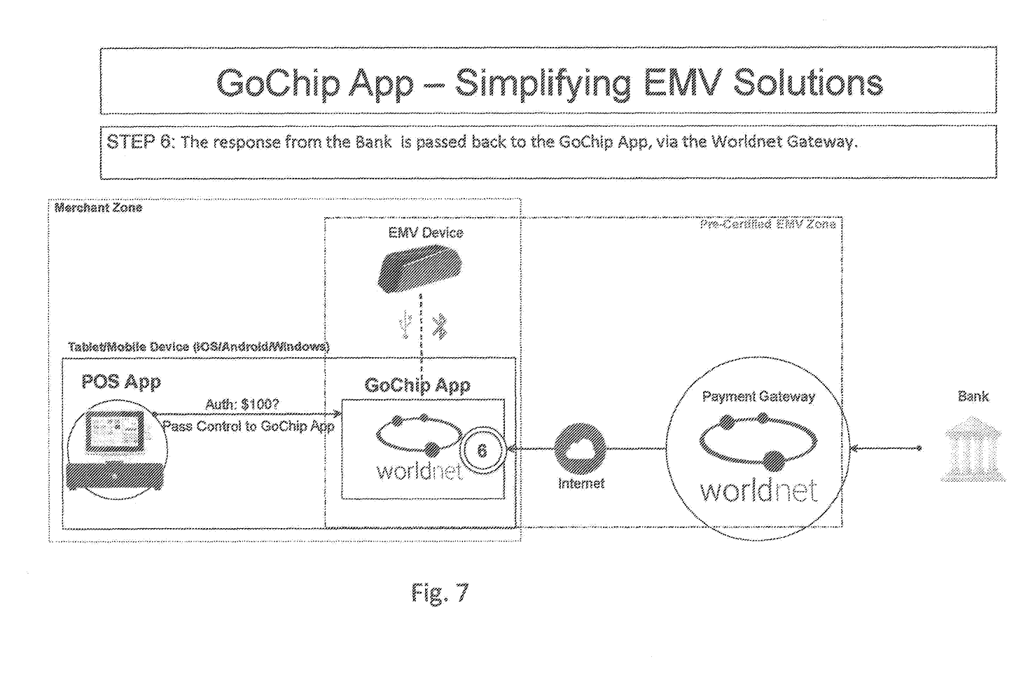

Step 6 (see FIG. 7): The invention runs as a separate, standalone app on the mobile device, and processes the EMV transaction. The invention uses an external Payment Gateway (referred to herein as WorldNet or WorldNet Gateway) to route the transaction to the processing Bank for authorization.

The external payment gateway is compatible with Android and iOS phones and tablets. Enables processing payments by credit and debit cards securely over WiFi, 4G, 3G or Edge.

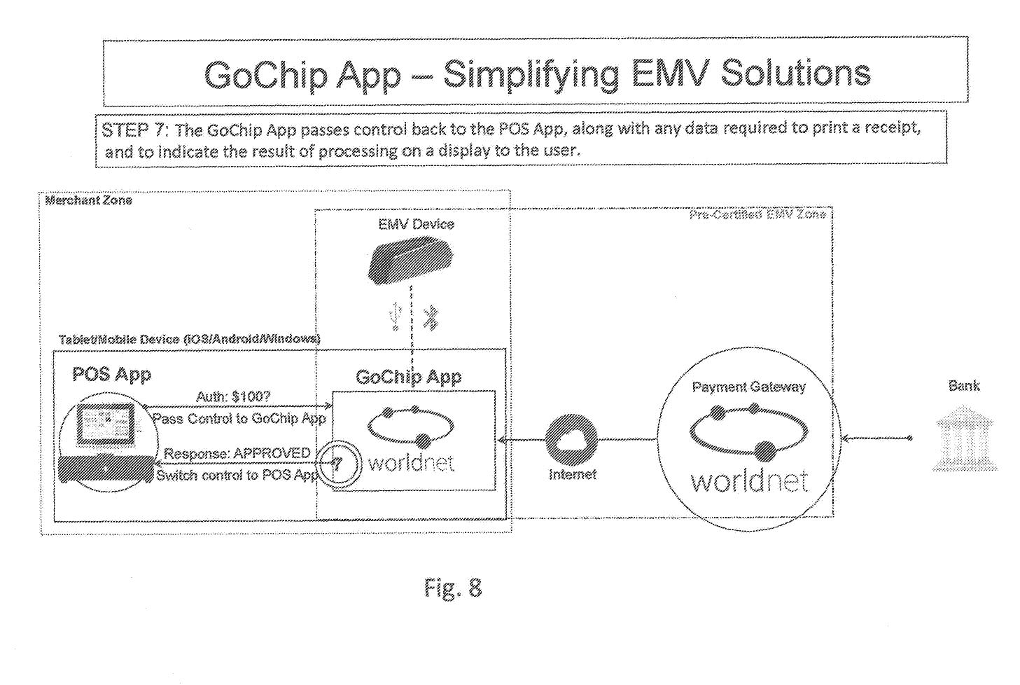

Step 7: Once authorization is completed, the GoChip App transfers control back to the POS App, indicating whether the credit card transaction was processed successfully or not. The GoCHip app can also use the “App Switchback” capabilities to pass any required data back to the POS app, such as data required for the printing of a receipt by the POS App, and to indicate the result of processing on a display to the user. See FIG. 8.

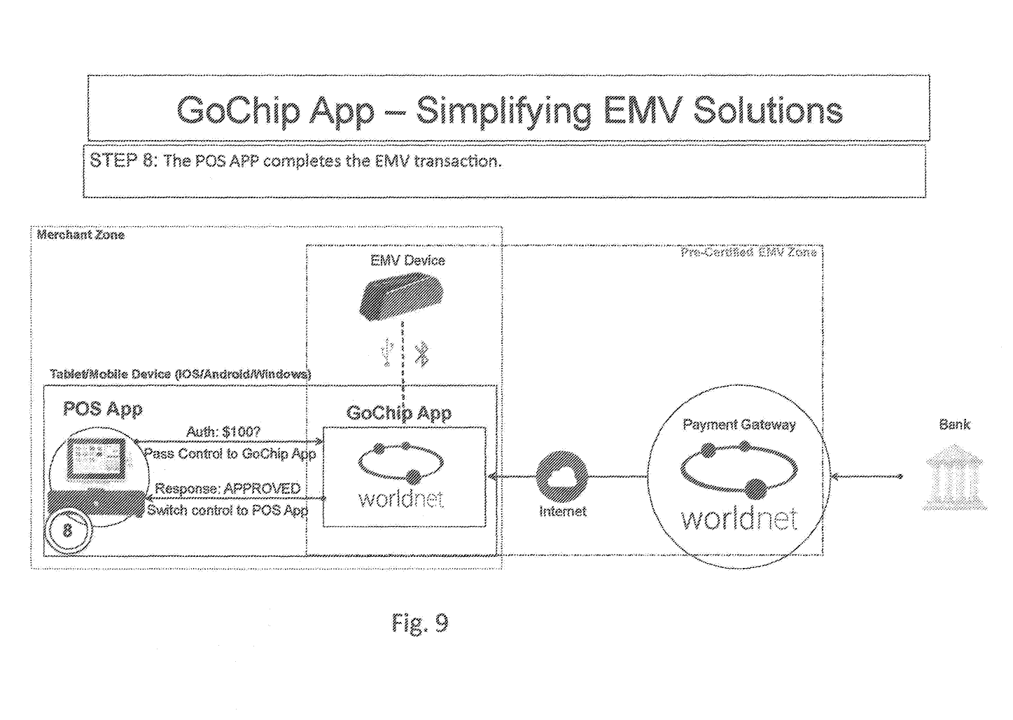

Step 8: Pass control back to the POS App, EMV transaction is completed. See FIG. 9.

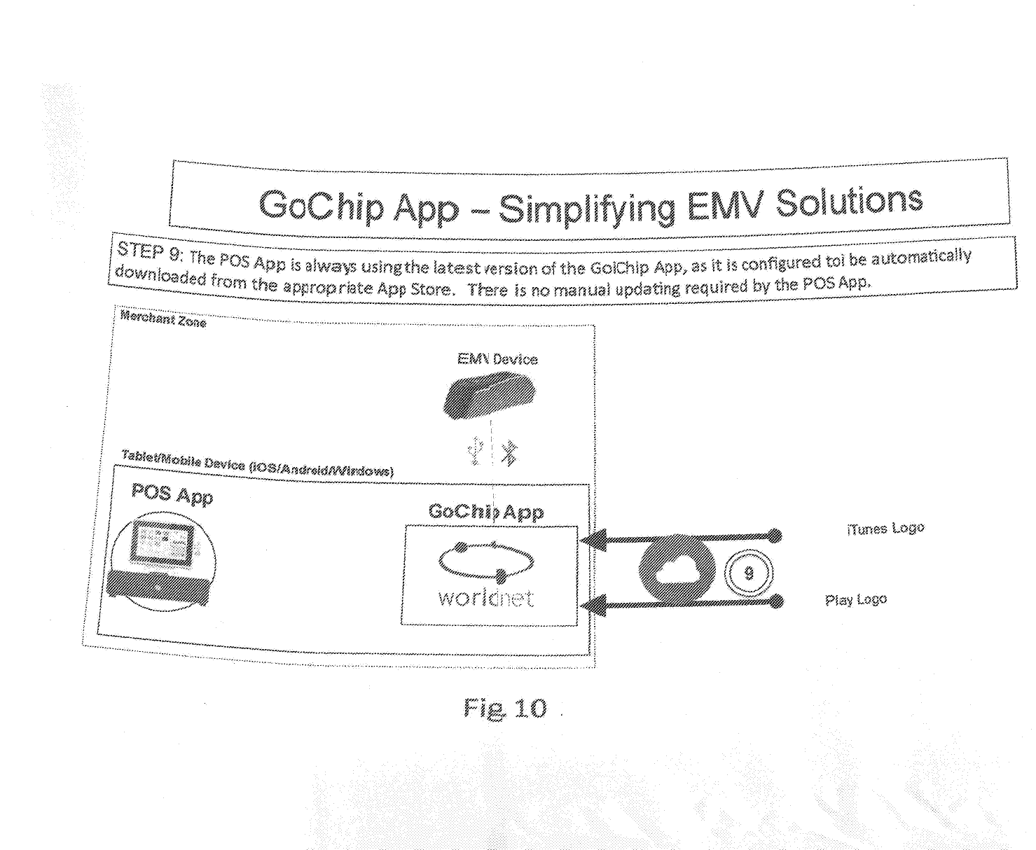

Step 9: automatic updating of GoChipApp: See FIG. 10. The latest version of the GoChipApp is automatically downloaded, thus the POS is always using the most current version.

The invention provided through an EMV device, the GoChip App, and a WorldNet Gateway, enabling any POS App to eliminate integration, to eliminate EMV certification, and to automatically receive updates.

The invention drastically reduces the amount of time required for a POS developer to deploy a certified EMV solution to their merchants. The invention accomplishes in a day or two what previously required months of labor.

The invention also automates version updating. The invention eliminates the need for POS developers to manually provide software updates for credit card processing to their merchants.

It can be appreciated that other embodiments exist that are not set forth herein yet which fall within the scope of the claims hereto, and the subject matter of the drawings filed herewith.

We claim:

1. A mobile device credit card payment method, where, at point of sale, a request is made for a credit transaction on said mobile device by a point of sale application, said method comprising the steps of:
sending code from point of sale application running on said mobile device to a second application running on said mobile device, wherein said second application performs the steps of:
identifying chip device;
interacting with chip device;
collecting information;
communicating with entity performing transaction certification; and when receives response from bank via entity performing transaction certification, communicating with said first app at point of sale; and
said first application at point of sale provides any of data, receipts, and display on screen.

2. An improved mobile credit card EMV processing method, said improvement comprising:
launching a second application together with POS (point of sale) application where said second application is directable by said point of sale application to process amount of transaction, and said second application identifies EMV device, and said second application performs transaction certification and communicates with said point of sale application, so that said point of sale application does not itself require transaction certification.

3. An improved system for mobile credit card EMV transactions, where mobile credit EMV transaction consist of a mobile device, an EMV credit card, and a point of sale application, said improvement comprising:
a second application running on said mobile device along with said point of sale application;
a preauthenticated payment channel, such that said point of sale application communicates transaction amount to said second application, and said second application uses said preauthenticated payment channel, so that said point of sale application does not require certification.
